(19) United States
(12) Patent Application Publication
(10) Pub. No.: US 2003/0196082 A1
(43) Pub. Date: Oct. 16, 2003

(54) Security management system

(75) Inventor: Shin-Ichi Fukuyama, Tokyo (JP)

Correspondence Address: ARMSTRONG,WESTERMAN & HATTORI, LLP, 1725 K STREET, NW, SUITE 1000, WASHINGTON, DC, 20006, US

(73) Assignee: YOKOGAWA ELECTRIC CORPORATION, Tokyo (JP)

(21) Appl. No.: 10/387,374

(22) Filed: Mar. 14, 2003

(30) Foreign Application Priority Data
Apr. 10, 2002 (JP) 2002-107715

(51) Int. Cl. G06F 11/30

(52) U.S. Cl. 713/153; 713/201

(57) ABSTRACT

The present invention is characterized by the following points:

A monitoring station is provided in a network to which systems are connected. Data, when sent from a transmission source to a transmission destination, are passed once through the above monitoring station in which security checks are implemented. When remote services or the like are carried out between enterprises, this method enables communications for which an ensured, definite level of security check has been implemented,—and also enables the prevention of the diffusion of viruses.

### BACKGROUND OF THE INVENTION

1. Field of the Invention

The present invention relates to a security management system which manages communications security between systems connected to a network.

2. Description of the Prior Art

Needs for remote monitoring, remote operation, remote maintenance, and the like utilizing the Internet are increasing. As such needs increase, unauthorized access to network and their susceptibility to viruses, etc. are causing increased anxiety in network security. If these problems occur in networks between the main office and the factories or business divisions of a firm, management and responsibility for these problems can be handled as in-house affairs. However, for networks between enterprises, for example, if vendors including set manufacturers, plant manufacturers, equipment manufacturers, etc. remotely carry out services for a user's system or systems, a very high level of security is required.

Although there are several techniques for high security communication methods using the Internet, if the other party of communication is fixed, a cryptographic communication technique using a Virtual Private Network (VPN circuit) is commonly used.

FIG. 1 is a configuration drawing of a security management system using conventional VPN circuit.

In FIG. 1, service provider system 3, service client A's system 4, and service client B's system 5 are connected to Internet 1 via provider 2.

In service provider system 3, remote service computer 33 is connected to Internet 1 via router 31 and VPN circuit 32.

In service client A's system 4, monitoring objects 43 and 44 are connected to Internet 1 via router 41 and VPN circuit 42. Local Area Network (LAN) 45 and LAN 46 are laid out in system 4.

In service client B's system 5, monitoring object 53 is connected to Internet 1 via modem 51 and VPN circuit 52.

In this case, monitoring objects 44 and 53 are, for example, Programmable Logic Controllers (PLC), and monitoring object 43 is, for example, an operation and monitoring station of a process control system.

Service provider system 3 offers remote services for monitoring the monitoring objects to service client A's system 4 and service client B's system 5. Remote services include, for example, a service in which service provider system 3 monitors process data for monitoring objects located in service client A's system 4 and service client B's system 5. When the remote services are provided, system 3 communicates with systems 4 and 5.

In the system shown in FIG. 1, the process data for monitoring objects located in service client A's system 4 and service client B's system 5 are sent to service provider system 3 through Internet 1 after being encrypted by VPN circuit. They are decrypted by another VPN circuit located in service provider system 3. This system can prevent unauthorized access to networks and their possible contamination by viruses during communication.

Although Internet security is ensured by a VPN circuit, it is based on the premise that internal networks are secure on both the remote service provider and client sides. Accordingly, for connections between business divisions in an enterprise, the above system can be recognized to be secure only to the extent to which the entire security policy is unified.

Therefore, the above system is still subjected to the danger that internal unauthorized access and viruses in the service provider or client(s) may in turn contaminate the other party of communications via the VPN circuit. With a provider capable of communicating with a plurality of clients, viruses that have infected a client have high possibilities of being propagated to another client via the provider. This demonstrates that the existence of a VPN circuit can inversely bring a calamity upon itself, and that viruses can pass through the unauthorized access detecting functions that each enterprise incorporates.

In cases where each organization is a unique enterprise, and there are differences in each one's in-house security policy or security level, much uneasiness is felt about direct connections between enterprises using VPN circuits, and therefore such direct connections are impractical. In the example shown in FIG. 1, service client A's system 4 is the system of a large enterprise whose security level is high, and service client B's system 5 is the system of a small-to-medium-sized enterprise whose security level is low. For this reason, regardless of how high the security level of service client A's system 4 is made, viruses may intrude from service client B's system 5.

Since viruses intrude from the part of the system having the lowest security level, a dangerous condition may occur unless the security levels in the service provider (vendor side) and service client (user side) are both high.

If unauthorized access to one user influences another user via a vendor's system, confidence in the vendor may be lost.

### SUMMARY OF THE INVENTION

The present invention is intended to solve the above described problems. The objective of the present invention is to achieve a security management system that can ensure communications in which a definite level of security protection is performed, as well as one capable of preventing the diffusion of viruses in remote services carried out between enterprises by routing data through a monitoring station when the data are sent from the transmission source to the transmission destination and by implementing security checks at the monitoring station.

### BRIEF DESCRIPTION OF THE DRAWINGS

[FIG. 1]

FIG. 1 is a configuration drawing of a conventional security management system.

[FIG. 2]

FIG. 2 is a configuration drawing showing an embodiment of the present invention.

[FIG. 3]

FIG. 3 is a drawing indicating the configuration of an essential part of the embodiment concerning the present invention.

### DETAILED DESCRIPTION OF THE PREFERRED EMBODIMENTS

The present invention will be described below in detail with reference to the drawings.

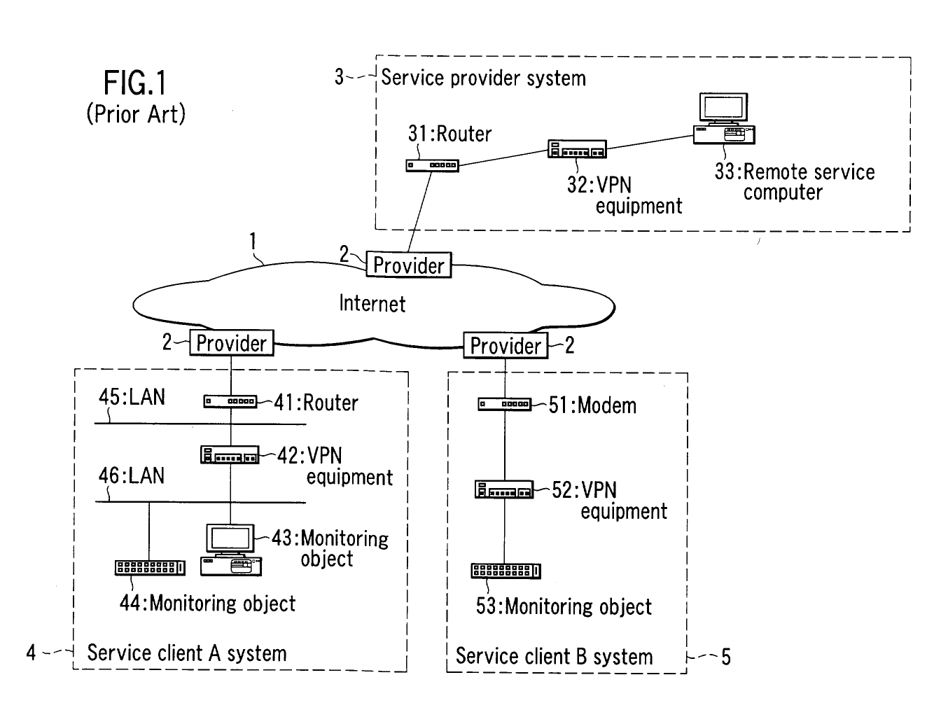

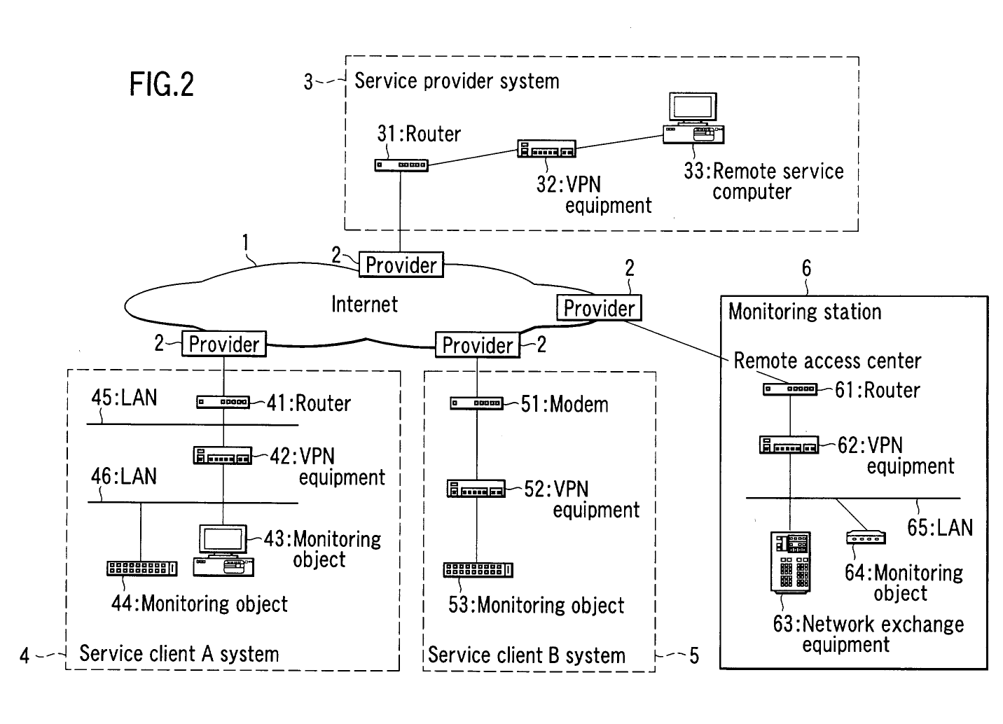

FIG. 2 is a configuration drawing showing an embodiment of the present invention. In FIG. 2, parts identical to those shown in FIG. 1 are labeled the same.

In FIG. 2, communications between a service provider and service clients pass through monitoring station 6. Monitoring station 6 implements security checks by acquiring the data sent from a system in a transmission source. If it is determined that there are no problems as a result of checks, monitoring station 6 sends the acquired data to a system in a transmission destination. If any abnormalities are detected as a result of the checks, these data are not sent out. Monitoring station 6 carries out functions as a remote access center.

Network exchange equipment 63 and monitoring equipment 64 are connected to Internet 1 via router 61 and VPN circuit 62. LAN 65 is laid out within monitoring station 6 and connected with network exchange equipment 63 and monitoring equipment 64. Network exchange equipment 63 acquires data then sends out the acquired data. Monitoring equipment 64 implements security checks to data sent to monitoring station 6. For example, monitoring equipment 64 implements security checks when data are acquired into network exchange equipment 63 and when data are sent out from network exchange equipment 63, respectively. Monitoring equipment 64 monitors unauthorized access and viruses.

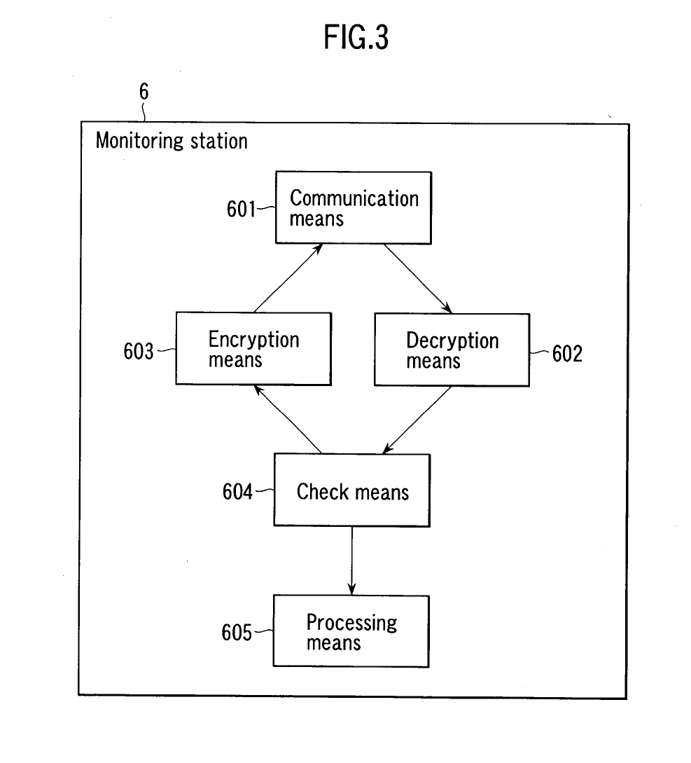

FIG. 3 is a configuration block diagram of monitoring station 6.

In FIG. 3, communication means 601 is provided for monitoring station 6 to communicate via Internet 1. Communication means 601 is located in router 61.

Decryption means 602 decrypts the data acquired by monitoring station 6. Encryption means 603 encrypts the decrypted data. Decryption means 602 and encryption means 603 are located in VPN circuit 62.

Check means 604 implements checks to the data decrypted by decryption means 602 for unauthorized access and viruses. If there are no problems as a result of checks, check means 604 sends the data to encryption means 603. These data are again encrypted by encryption means 603 and then sent out to Internet 1.

Processing means 605 cuts off communication of those data if abnormalities have been detected as a result of security checks. When very dangerous viruses are being spread and vaccine against these viruses is not available in time, communication is cut off even if the viruses are not intruding in the data. In addition, processing means 605 periodically offers reports of security check results or information concerning security, and notifies the parties concerned of emergency information if abnormalities have been detected as a result of security checks.

Check means 604 and processing means 605 are located in monitoring equipment 64.

Operation of the systems shown in FIG. 2 and FIG. 3 will be described.

Both the service provider and service clients carry out all communications through monitoring station 6 which functions as the remote access center. Data from service client A's system 4 and service client B's system 5 are encrypted through VPN circuit 42 and 52 and are sent to monitoring station 6 via Internet 1. In monitoring station 6, the data sent are decrypted by VPN circuit 62. For these decrypted data, monitoring equipment 64 checks unauthorized access and viruses. If there are no abnormalities detected as a result of the checks, the data are again encrypted by VPN circuit 62 and are sent to service provider system 3 via Internet 1. In service provider system 3, the data are decrypted by VPN circuit 32. Communications in the inverse direction are the same as those above. If any abnormalities are detected in the checks by monitoring equipment 64, monitoring equipment 64 cuts off communication of these data to prevent their influence on the other party of communication and other service clients.

When communication is to be implemented, an address is attached to the communication frame so that the data are transmitted to the transmission destination after passing through monitoring station 6.

For both the service provider and the service clients, their other parties of connection are determined in advance by contracts and fixed by setting Internet Protocol (IP) Addresses and VPN circuit. Although communication data are all sent to monitoring station 6 once, it seems as if either the service provider or the service client is communicating directly with predetermined other parties only, regardless of monitoring station 6 which is inserted between the service provider or the service client and its other parties via the Internet, if the communications are viewed from the service provider side or the service client sides. Therefore, private communication can be ensured even while these parties are connected to the Internet, without interference from either the monitoring station or the Internet. At the same time, since these communications are under unified management by monitoring station 6, various services become enabled by monitoring station 6 always recognizing their communication states, not limited to checks for unauthorized access and viruses.

Private communications using the Internet are already in practice, monitored by VPN circuit and these facilitate secure communications to a degree between the parties concerned. By inserting the third party (monitoring station 6) between the parties concerned, specific N:N communication can be achieved securely. At the same time, various additional services, such as remote monitoring, remote running, remote maintenance, remote engineering, etc. can be provided. These can be implemented as elements of a service provider's business (services carried out by service provider system 3). The present invention offers secure infrastructures for these services.

Further, monitoring station 6 may perform part of the services that are carried out by service provider system 3 for that system. For example, in 24 hour security monitoring work, monitoring station 6 may perform the monitoring only over a predetermined time period at night for a service provider system.

In addition, monitoring station 6 may receive contracts at the request of a service provider for management jobs such as storage or taking charge of system information and data of a service provider's service clients. These management jobs are those which a service provider carries out for its service clients.

Communications, conducted between a service provider system and a service client system, are inter-enterprise communications or business to business communications (B to B communications).

Furthermore, communications between service providers and service clients may either be 1:N communications or N:N communications.

According to the present invention, the following effects can be obtained:

(a) In secure communications using VPN circuit, their security is maintained on the premise that both systems are internally secure. Specifically, in 1:N or N:N B to B communications, it is difficult to establish and maintain such a premise. Vulnerability at any location could become a security leak and thus the other party of communication could be easily attacked by unauthorized access or viruses without impediment from the VPN circuit.

According to the present invention, a monitoring station as a third party is inserted in the communication line connecting a service provider system and a service client system, and security monitoring and virus monitoring are carried out here. This enables a definite level of security to be ensured for communications between a service provider system and a service client system. Also, this monitoring system prevents unauthorized access and viruses that have intruded into the service client system from diffusing to other service client systems via the service provider system.

(b) Even if at least one of either the service provider system or the service client system is composed of more than one system, communication security can be assured to a definite level.

(c) Not only is the burden of assuring the security of the service provider'system reduced, but the burden of services carried out by the service provider system itself can also be reduced.

(d) For communications in providing remote monitoring, remote running, remote maintenance, and remote engineering services, a definite level of security can be assured.

(e) Security for B to B communications can be assured to a definite level.

What is claimed is:

1. A security management system which manages security for communications between systems connected to a network; comprising a monitoring station that acquires data sent from a system as a transmission source, implements security checks for the acquired data, and if there are no problems as a result of the checks, sends the acquired data to a system as a transmission destination.

2. A security management system in accordance with claim 1, wherein said system as a transmission source sends out encrypted data to a network, said monitoring station decrypts the acquired data and implements security checks for the decrypted data, and if there are no problems as a result of checks, sends these data to a system as a transmission destination after again encrypting them.

3. A security management system in accordance with claim 1 or claim 2, wherein said monitoring station cuts off communication of the data if any abnormalities have been detected as a result of security checks of the data.

4. A security management system in accordance with claim 1 or claim 2, wherein said monitoring station periodically reports the result of security checks or offers information on security, and if abnormalities have been detected as a result of security checks, notifies the parties concerned of emergency information.

5. A security management system in accordance with any of claims 1 to 4, wherein systems connected to a network include service provider systems and service client systems.

6. A security management system in accordance with claim 5, wherein said service provider systems and service client systems carry out 1:N or N:N communications.

7. A security management system in accordance with claim 5, wherein said monitoring station performs part of the services that are carried out by a service provider system for that system.

8. A security management system in accordance with claim 5, wherein said monitoring station receives a contract for management jobs that a service provider system carries out on a service client's system from the service provider.

9. A security management system in accordance with claim 5, wherein said service that a service provider system carries out is at least one of remote monitoring, remote running, remote maintenance, or remote engineering.

10. A security management system in accordance with claim 5, wherein communications between said service provider system and said service client system are business to business communications.
